(19) United States
(12) Patent Application Publication
(10) Pub. No.: US 2024/0386810 A1
(43) Pub. Date: Nov. 21, 2024

(54) Method for training to cope with a fault affecting one powertrain of a hybrid propulsion system

(71) Applicant: SAFRAN HELICOPTER ENGINES, Bordes (FR)

(72) Inventors: David Bernard Martin LEMAY, Moissy-Cramayel (FR); Jean-Philippe Jacques MARIN, Moissy-Cramayel (FR)

(21) Appl. No.: 18/687,576

(22) PCT Filed: Aug. 29, 2022
(86) PCT No.: PCT/FR2022/051622

§ 371 Date: Feb. 28, 2024

(30) Foreign Application Priority Data
Aug. 31, 2021 (FR) 2109059

(51) Int. Cl. G09B 9/44; B64D 27/33; G09B 9/46

(52) U.S. Cl. CPC G09B 9/44; G09B 9/46; B64D 27/33

(57) ABSTRACT

A method for training a pilot to cope with a fault affecting one powertrain of a hybrid propulsion system for an aircraft. The aircraft includes, connected in parallel to a transmission unit, n powertrains (where n≥2), including a first and a second powertrain that are heterogeneous in nature. It involves, during a flight of the aircraft, simulating a fault affecting the first powertrain while, at the same time as performing the simulation, checking the status of the n powertrains of the propulsion system. If a fault affecting one of the n powertrains is detected, the simulation is halted and the instantaneous power delivered by at least one of either the first or the second powertrain is increased so that the sum of the instantaneous powers delivered by the n powertrains is ≥ a minimum total instantaneous power required for the aircraft to continue its flight.

### TECHNICAL FIELD

The present invention relates to a method for assisting the training of aircraft pilots to cope with a fault the fault affecting a powertrain from among a set of at least two redundant parallel powertrains of an aircraft equipped with a redundant hybrid propulsion system. It applies to propulsion and lift systems for fixed or rotary wing aircrafts (helicopter), or vertical take-off and landing aircrafts (VTOL, standing for “Vertical Take-Off and Landing aircraft”).

### PRIOR ART

Techniques for simulating a fault affecting an engine for training two-engine (or three-engine) helicopter pilots have been known for several years.

The principle of simulating a fault affecting a motor of a multi-engine helicopter is known, consisting in lowering the power of the two engines (or more than two) to a level corresponding to the emergency maximum power that one single engine (or engines remaining available after the fault affecting one of them) is capable of delivering (so-called OEI/2 simulation method, standing for “One Engine Inoperative”).

A method is known from the document [1] for forming an aircraft pilot to address the fault affecting one or more engine(s) of a multi-engine aircraft in flight. The software simulates an engine fault using output power limits imposed by software on the engine(s) a fault of which is simulated. For example, in the case of two engines, an imbalance is created between the two engines by bringing the engine simulated as operating to its continuous maximum power in the event of a fault affecting another engine (or OEIC power, standing for “One Engine Inoperative Continuous” Power) and the other engine simulated as defective supplies the complement for the rotor (so-called significantly lower level).

A method and a system are known from the document [2] for simulating conditions of a faulty engine (OEI method) in a multi-engine aircraft which involves the operation of the engines above non-zero power settings, and each operating with respect to one another in order to simulate the loss of power experienced during an actual fault affecting at least one engine. More particularly, the transient power hole experienced by the pilot when a true engine failure occurs is simulated by transiently limiting the power delivered by the two engines below their emergency maximum power.

Hybrid powerplant management architectures and methods are also known, composed of one or more main engine(s) and one or more secondary engine(s) intended to be able to compensate for a loss of power of at least one main engine. The documents [3] and [4] mention these solutions.

In the case of hybrid propulsion systems, a simple and well-known solution for training at coping with a fault affecting an engine is to set this same engine at idle so that it delivers almost no power to the rotor. The pilot can then be trained in flight while having only the remaining powertrain(s) available, this (or these) powertrain(s) could be achieved only by the secondary engine(s) of a nature different from the engine simulated as faulty (for example, one (or more) electric motor(s)).

A representative, yet non-limiting, example of an aircraft and its hybrid propulsion system may consist of a helicopter provided with a main rotor and a tail rotor, referred to as anti-torque rotor.

The helicopter is equipped with a main powertrain having a main engine which supplies mechanical power to the two rotors via a main transmission unit (BTP). For example, this main engine may be a helicopter turboshaft engine; this main engine supplies most of the power necessary for the flight of the helicopter.

The helicopter is also equipped with an electric secondary powertrain, which consists of:
an electric motor, which supplies mechanical power to the two rotors via a second input on the BTP;
power and control electronics, which allow modulating the power delivered by the electric motor;
electrical distribution members; and
an electric power source that could be a battery.

This secondary powertrain is essentially intended to supply a minimum power level to ensure a safe, yet rapid, landing of the aircraft. Hence, the maximum power available by the electric motor is significantly lower than that provided by the main engine. Hence, the flight domain and the permitted manoeuvres are very limited. In the event of a fault affecting at least one propulsion engine of an aircraft, in particular with a rotary wing, the available maximum power is lower than the power that is available under normal operating conditions (with no fault). Piloting the aircraft is then more complex and requires dedicated learning and training of the pilots. In general, these trainings consist in “simulating” the fault affecting an engine in flight and requesting the pilot to pilot the aircraft and to land under these degraded conditions.

The evolution of technologies allows introducing hybrid propulsion systems, integrating one or more powertrain(s) of a nature other than the main engine(s). In particular, mention may be made of electric or hydraulic powertrains.

These powertrains of another nature than the main engine(s) may be dimensioned so as to be able to supply a maximum power equivalent to or significantly lower than the main engine(s); they may have the essential function of supplying emergency “back-up” power in the event of a fault affecting a main engine.

The particularity of these hybrid systems (compared to installations of several identical engines) is that the maximum power regimes and the dynamics of variation of the power could be very different from the main engines. Hence, the control ergonomics could be affected too much in actual fault or fault training situations. Hence, these trainings should be faithful of these differences in behaviour in order to be representative of actual fault situations.

Finally, the major drawback of the above-described technique for training at coping with an engine failure (i.e. setting the engine deemed to be faulty at idle) is that, in the event of an actual fault affecting one of the remaining powertrains during the training, The reactivation and power-up time of the idling engine is very long. Hence, the safety of the flight might be degraded too much during the few seconds following the occurrence of the fault affecting a powertrain.

The turboshaft engine manufacturers have developed the so-called “CAA” (standing for “Civil Aviation Authority”) training to solve the safety problem, but sometimes to the detriment of representativeness. This training mode is also known as OEI/2, since the two engines are limited to the power OEI/2.

To sum up, the invention aims to provide a solution to the following problems:
allowing training pilots at flying with a faulty engine (i.e. when a fault affecting one of the elements of a propulsion or lift chain is simulated);
ensuring a high level of safety by maintaining the engine simulated as affected by a fault on an operating regime providing it with sufficient responsiveness in the event of an actual fault affecting the powertrain simulated as operational (in particular, it is necessary to be able to deal with any actual fault affecting the powertrain during the training without any danger to the aircraft, which involves a good responsiveness of the elements of the powertrain that is still operational after the actual failure);
on an aircraft equipped with a hybrid propulsion system comprising n parallel powertrains (n being an integer greater than or equal to 2) including at least one first and one second powertrains that are heterogeneous in nature, the first and second powertrains preferably having very different power and/or dynamic performances; in fact, all of the n chains will be used to simulate the fault affecting the first chain, by simulating the loss of an amount of power equivalent to the maximum power of the first powertrain; for example, for the order of magnitude of the first and second powertrains, in terms of power, it is possible to have a maximum power level of the second powertrain at least 30% lower than that of the first powertrain and, in terms of dynamics, dynamics of the second powertrain at least twice as rapid as the first powertrain;
without excessively loading each of the elements of the powertrain(s) remaining active.

### DISCLOSURE OF THE INVENTION

To do so, an object of the invention is a method for training a pilot at coping with a fault affecting a powertrain of a hybrid propulsion system for an aircraft comprising n powertrains connected in parallel on a transmission unit, n being an integer greater than or equal to 2, including first and second powertrains that are heterogeneous in nature, the method comprising, during a flight of the aircraft, simulating a fault affecting the first powertrain by implementing the following steps:
decreasing the instantaneous power P_{M1inst} delivered by the first powertrain down to a training power P_{M1Ecol} and maintaining this power P_{M1Ecol} until the end of the simulation, with:

P_{M2max_OEI}>P_{M1Ecol}>P_{M1min}

P_{M2max_ OEI} being the instantaneous maximum power that could be delivered by the second powertrain when not in the training mode and P_{M1min} being the instantaneous minimum power that could be delivered by the first powertrain; and
increasing the instantaneous power P_{M2inst} delivered by the second powertrain up to a power that is lower than or equal to an upper limit power P_{M2lim_Ecol} applicable to the second powertrain during the training mode, and regulating the power P_{M2inst} during the simulation so that the instantaneous total power P_{tot_Ecol} delivered by the first and second powertrains during the training mode is lower than or equal to P_{M2max_OEI}, with:

$${P}_{tot \_ Ecol} = {P}_{M 1 Ecol} + {P}_{M 2 inst} \\ {P}_{tot \_ Ecol} \leq {P}_{M 2 max \_ OEI} \\ {P}_{M 2 inst} \leq {P}_{M 2 {lim}_{-} Ecol} < {P}_{M 2 max \_ OEI} \\ {P}_{M 2 {lim}_{-} Ecol} + {P}_{M 1 Ecol} = {P}_{M 2 max \_ OEI}$$

P_{M2lim_Ecol} being the maximum power that could be delivered by the second powertrain in the training mode so that P_{tot_Ecol} does not exceed P_{M2max_OE1}; the method further comprising, at the same time as performing the simulation, checking the status of the n powertrains of the propulsion system and, if a fault affecting one of the n powertrains is detected, stopping the simulation and increasing the instantaneous power delivered by at least one amongst the first and second powertrains, so that the sum of the instantaneous powers delivered by the n powertrains is higher than or equal to P_{Rmin_OEI}, P_{Rmin_OEI} being a minimum total instantaneous power required for the aircraft to continue its flight.

More specifically, P_{Rmin_OEI} is the minimum power necessary to continue the flight in satisfactory safety conditions; this power depends only on the characteristics of the aircraft and it is independent of the fact of being in the training mode, in nominal flight or in the event of a fault. For example, on a twin-engine helicopter, this generally corresponds to the OEI30″ (or SEP, standing for “super-emergency power”), and on a single-engine helicopter, at 90% MTOP (MTOP, standing for “maximum take-off power”).

It is specified that, to clearly distinguish the limitations applied in the training mode (i.e. during the simulation) of those present when not in the training mode (for example in the event of a real fault case), the indices “_Ecol” and “_OEI” have respectively been added (for example P_{M2lim} and P_{M2min} during the training mode are written PM2lim_Ecol and PM2min_Ecol, and P_{M2max} when not in the training mode is written P_{M2max_OEI}).

Furthermore, it should be noted that P_{M2max_OEI} and P_{M2max} are strictly identical and both refer to the maximum power that the second powertrain can deliver in the event of a real failure (i.e. when not in the training mode).

Moreover, it should be noted that, in the context of the present invention, we indifferently talk about training or training mode.

Some preferred yet non-limiting aspects of this method are as follows.

Advantageously, the second powertrain is selected from among a hydraulic or electrical type powertrain, and the first powertrain is selected from among a gas turbine type powertrain.

According to a variant of the invention where the second powertrain is reversible, the step of increasing the instantaneous power P_{M2inst} delivered by the second powertrain may be preceded by a step of drawing, by the second powertrain, a portion of the instantaneous power P_{M1} delivered by the first powertrain to the transmission unit, whereby a faster drop in the instantaneous total power P_{tot_Ecol} delivered by the first and second powertrains during the simulation is obtained.

According to one variant, the step of reducing the instantaneous power P_{Minst} delivered by the first powertrain includes a transient reduction in the power of the first powertrain below P_{M1Ecol}, followed by an increase in the power of the first powertrain up to P_{M1Ecol}. According to one variant, the triggering of the step of increasing the instantaneous power

PM2inst delivered by the second powertrain is delayed and/or the increase in the instantaneous power P_{M2inst} delivered by the second powertrain is slowed, whereby a transient power hole is created.

According to one variant, the second powertrain being reversible and PM1Ecol being selected so as to be higher than or equal to P_{Rmin_Ecol} (P_{Rmin_Ecol} being the minimum total instantaneous power required for the aircraft to continue its flight in the training mode), a step of drawing a portion of the power delivered by the first powertrain to the transmission unit is carried out, by the second powertrain, at least once during the step of increasing the power delivered by the second powertrain, the maximum portion P_{M2min_Ecol} that could be drawn being a negative value and being equal, in absolute value, to the maximum power that the second powertrain could draw from the transmission unit in the training mode, with P_{M1Ecol}+P_{M2min_Ecol}≤P_{Rmin_Ecol}. It is specified that P_{M1Ecol}≥P_{Rmin_Ecol} is selected so as to maximise the power of the first powertrain during the fault training phase (training), in order to be able to offer the maximum responsiveness of the first powertrain to return to its maximum power, in the event of an occurrence of a real fault affecting one of the (n-1) other powertrains during this training phase; in other words, the constraints could be summarised as follows:
to comply with the minimum power:

$${P}_{M 1 Ecol} + {P}_{M 2 min \_ Ecol} = {P}_{R min \_ Ecol}$$

where P_{M2min_Ecol} is the maximum power (in absolute value) that the second powertrain can draw in the training mode (knowing that P_{M2min_Ecol} may be negative); and
to comply with the maximum power:

$${P}_{M 1 Ecol} + {P}_{M 2 {lim}_{-} Ecol} = {P}_{M 2 max \_ OEI}$$

where P_{M2lim_Ecol} is the maximum power that the second powertrain can deliver in the training mode so that P_{tot_Ecol} does not exceed P_{M2max_OEI}. According to one variant, the power PM1Ecol of the first powertrain and the power limit of the second powertrain P_{M2lim_Ecol} are adapted in real-time during the simulation, so that an average of the power of the second powertrain during the simulation is equal to a reference power PM2ref selected so as to guarantee a margin for piloting the aircraft, with P_{M2min}<P_{M2ref}<P_{M2lim_Ecol} and P_{M2lim_Ecol}(t)+P_{M1Ecol}(t)=P_{M2max_OEI}

Another object of the invention is a device for training a pilot at a fault affecting a powertrain of a hybrid propulsion system for an aircraft comprising n powertrains, n being an integer greater than or equal to 2, including first and second powertrains that are heterogeneous in nature and connected in parallel on a transmission unit, the device comprising control means configured to implement the training method as defined according to the invention.

The control means may include a regulation system, which will regulate the respective powers of the first and second powertrains, as well as a control system, which will control the respective powers of the n powertrains.

Finally, an object of the invention is an aircraft equipped with a hybrid propulsion system comprising n powertrains, n being an integer greater than or equal to 2, first and second powertrains that are heterogeneous in nature and connected in parallel on a transmission unit, and a training device as defined according to the invention.

The method according to the invention allows training pilots at flying under degraded conditions simulating a fault affecting one of the powertrains.

The method according to the invention allows distributing the power delivered by the at least two powertrains in an ingenious manner, so as to:
during the simulation, limit the total power delivered to the two powertrains to the maximum power of the powertrain that is deemed to be functional;
maintain the powertrain the fault of which is simulated at a sufficient operating regime so that it remains reactive, while making it “transparent” for the pilot;
offer a behaviour and dynamics of variation of the power delivered to the aircraft fully corresponding to that of the powertrain that is deemed to be operational;
detecting the occurrence of a fault affecting the powertrain that is deemed to be operational during the training, interrupt the training operation and very rapidly reactivate the powertrain simulated as faulty so that it supplies the power necessary for continuing the flight under satisfactory safety conditions.

### BRIEF DESCRIPTION OF THE DRAWINGS

Other aspects, aims, advantages and features of the invention will appear better upon reading the following detailed description of preferred embodiments thereof, given as a non-limiting example, and made with reference to the appended drawings wherein:

FIG. 1 schematically shows the architecture of an example of a hybrid propulsion system with two powertrains in parallel and its regulation system according to the invention;

FIG. 2 shows an example of power profiles in the event of an actual fault affecting one of the powertrains of the hybrid propulsion system of FIG. 1;

FIG. 3 shows an example of power profiles in the event of a simulated fault according to the invention affecting one of the powertrains of the hybrid propulsion system of FIG. 1;

FIG. 4 shows an example of the power loss profiles in the event of a simulated fault affecting a powertrain according to two variants of the invention in comparison with a real fault;

FIG. 5 shows an example of power profiles of a simulation of a fault affecting the first powertrain according to the variant 1 of the invention;

FIG. 6 shows an example of power profiles of a simulation of a fault affecting the first powertrain according to the variant 2 of the invention;

FIG. 7 is a detailed view of the regulation system 5 of FIG. 1, according to the variant 3 of the invention;

FIG. 8 shows an example of power profiles of a simulation of a fault affecting the first powertrain according to the variant 3 of the invention.

### DETAILED DISCLOSURE OF PARTICULAR EMBODIMENTS

The propulsion system used in the context of the invention is a system for generating and supplying propulsive power that is hybrid and redundant. In other words, the propulsion system is hybrid, because it includes at least two powertrains that are heterogeneous in nature and it is redundant, because these at least two powertrains are arranged in parallel on the transmission unit. This enables landing of the aircraft under satisfactory safety conditions in the event of a partial fault affecting one of the two powertrains. By “partial fault”, it should here be understood a fault that affects only one of the powertrains in parallel. Hence, the propulsion system as a whole is partially faulty since at least one of the redundant powertrains is functional.

A characteristic example of application is a parallel hybrid propulsion system of a helicopter, composed of a turboshaft engine and of an electric motor driving, both, the main and tail rotors.

In the following illustrative examples, the invention will be applied to a hybrid propulsion system composed of two independent powertrains in parallel (a so-called two-engine situation), namely a first powertrain with a gas turbine type engine and a second powertrain with an electric motor.

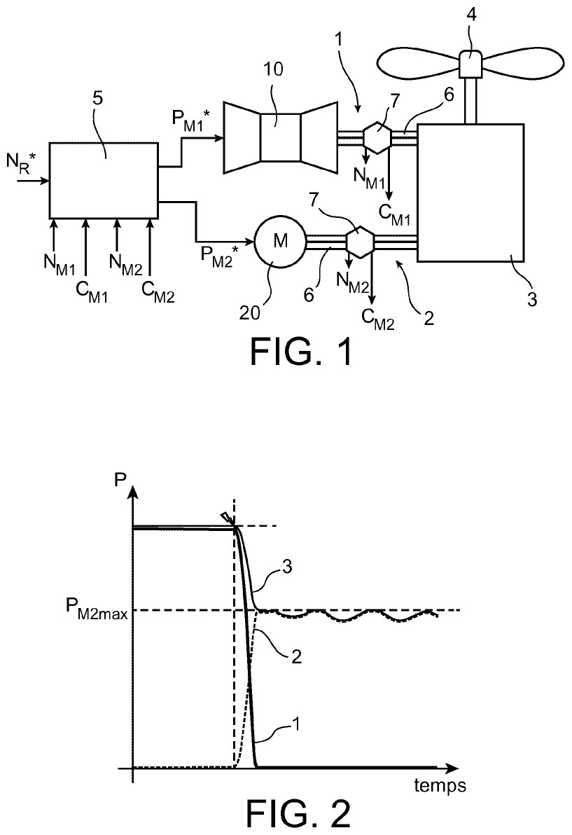

FIG. 1 shows the architecture of a hybrid propulsion system and its regulation system 5. In the particular application case illustrated in FIG. 1, the hybrid propulsion system includes two redundant powertrains, namely a main powertrain and a secondary powertrain, that we will respectively call first powertrain 1 and second powertrain 2. The two powertrains are independent and different in nature and they are redundant (it is also said that they are in parallel), i.e. they deliver mechanical power to the rotor 4 via a transmission unit 3 which adapts and sums up the powers of the two powertrains.

In this embodiment, the main powertrain 1 includes a heat engine 10 which could be a gas turbine, this main powertrain being designed so as to supply most of the power necessary for the flight of the aircraft. The secondary powertrain 2 includes one or more electric motor(s) (in this case, one single electric motor 20), and allows supplying a complementary power which essentially allows continuing the flight, in a restricted domain, until landing in satisfactory safety conditions. The primary function of this secondary powertrain 2 is to be able to overcome the fault affecting the main chain 1, while minimising the on-board additional mass. The maximum power that it can deliver is lower than or equal to the maximum power of the main powertrain.

In FIG. 1, N_{R}* is the rotational speed setpoint of the rotor 4 (also called propeller); N_{M1}

(N_{M2}) is the measurement of the speed of the engine of the first (second) powertrain; C_{M1} (C_{M2}) is the measurement of the torque delivered by the engine of the first (second) powertrain; P_{M1}* (P_{M2}*) is the power control of the engine of the first (second) powertrain. The data N_{R}*, N_{M1}, N_{M2}, C_{M1}, C_{M2} are delivered to the regulation system 5. The data P_{M1}* and P_{M2}* are respectively delivered to the heat engine 10 of the first powertrain 1 and to the electric engine 20 of the second powertrain 2. Each of the engines is connected by a shaft 6 to a main transmission unit 3, which will transmit the power of the engine(s) to the rotor. Each shaft is provided with a measuring device 7 allowing measuring the speed and the torque delivered by the engine to which it is related.

FIG. 2 shows the current total power delivered over time to the rotor of the aircraft of FIG. 1 (curve 3), in the event of an actual fault affecting the engine of the first powertrain. The curves 1 and 2 respectively represent the instantaneous power delivered over time by the first and second powertrains.

When there is a fault affecting the engine of the first powertrain (a fault symbolised by a flash), the power delivered by the first powertrain drops rapidly until complete stop. To overcome this fault, the power of the second powertrain is increased up to its maximum power P_{M2max}, which may be denoted P_{M2max_OEI} to explicitly signal the actual fault situation (when not in the training mode).

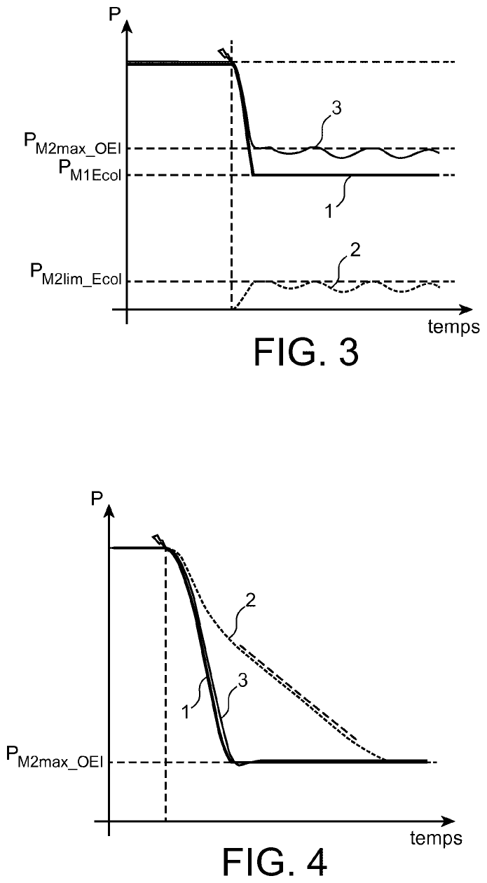

FIG. 3 shows the case of a simulated fault affecting the engine 10. Like in FIG. 2, the curves 1, 2, 3 respectively represent the instantaneous power delivered by the first powertrain, by the second powertrain and the current total power delivered over time to the rotor.

We initially start from an operating point where the current total power is higher than the maximum power of the engine deemed to be functional during the simulation phase. In this example, this consists of the engine of the second powertrain and the maximum power is therefore P_{M2max_OEI}. Indeed, the goal of the training mode is to simulate a flight situation where the available total power is limited by this maximum power of the second powertrain P_{M2max_OEI}.

When the training mode is selected by the pilot and the fault affecting the engine 10 is triggered, the regulation system 5 reduces the power delivered by the first powertrain as rapidly as possible, without turning it off. Thus, this rapid power reduction simulates the loss of power available to the rotor when the first powertrain fails.

To do so, the regulation system makes the engine 10 of the first powertrain decelerate at its maximum achievable deceleration rate without shutting off the combustion chamber. Thus, instead of reducing the power of the engine 10 until complete stop, the regulation system reduces the power of the engine 10 down to an intermediate power level PM1Ecol and it then keeps it constant until the end of the fault training operation. In other words, there is a deceleration transient phase (drop in initial power) of the engine 10 at the time of triggering of the training mode, then the power level is then maintained at a stabilised power level P_{M1Ecol}, the deceleration transient phase of the engine 10 being independent of the level P_{M1Ecol} at which it will then be maintained.

The selection of this power level P_{M1Ecol} of the engine 10 is the major advantage of this invention.

This level P_{M1Ecol} is selected, on the one hand, high enough for the engine 10 to preserve a sufficient acceleration capacity in order to be able to rapidly return to its maximum power should the engine 20 fail during the training operation. Hence, this allows improving the level of safety during the training phases. In general, the higher the power level P_{M1Ecol}, the quicker the engine 10 will be reactivated where necessary. Hence, the objective is to set the highest possible power level PM1Ecol while complying with the maximum power level of the engine 20 (P_{M2max_OEI}).

On the other hand, this level P_{M1Ecol} is also selected not too high so that the engine 10 does not influence the behaviour of the propulsion system felt by the pilot. As a reminder, the constraints may be summarised as follows:
P_{M1Ecol}+P_{M2min_Ecol}=P_{tot_min_Ecol}=P_{Rmin_Ecol}, to comply with the minimum power; and P_{M1Ecol}+P_{M2lim_Ecol}=P_{tot_max_Ecol}=P_{M2max_OEI}, to comply with the maximum power.

In this manner, the power of the engine 10 can be maintained constant. Hence, the variations in power of the rotor can be carried out entirely by the engine 20. Hence, the piloting behaviour is faithful to what the pilot would feel with the power delivered entirely by the engine 20.

FIG. 4 shows a comparison of the power loss profiles on a simulated fault and on an actual fault, the curve 1 representing the profile of an actual fault of the engine 10, the curve 2 representing the profile of the deceleration on the so-called “anti-extinction” limit of the engine 10 and the curve 3 representing the profile of a simulated fault according to the variant 1 of the invention. As illustrated in this FIG. 4, the deceleration on the “anti-extinction” limit of the engine 10 (curve 2) could, depending on the performances of the engine 10, be slower than the power drop observed in some fault cases (for example, in the case of tightening of the engine by loss of lubrication or cut-off of a fuel supply valve).

### Variant 1: Use of the engine 2 in the brake mode during the fault transient

In the variant 1, we act on the power drop initial transient phase at the time of entry into the training mode.

As we have just mentioned, a possible limitation of the engine fault simulation by controlling a controlled a deceleration of the regime of the engine 10 is that this maximum achievable deceleration can be significantly slower than a real power loss related to a real engine fault.

If the powertrain 2 of the engine 20 is reversible, i.e. the engine 20 can draw from the mechanical power of the BTP (whether by braking the BTP to recharge a battery or by dissipating the electric power), The engine 20 can be used to make the power delivered to the rotor drop quicker by drawing mechanical power from the engine 10.

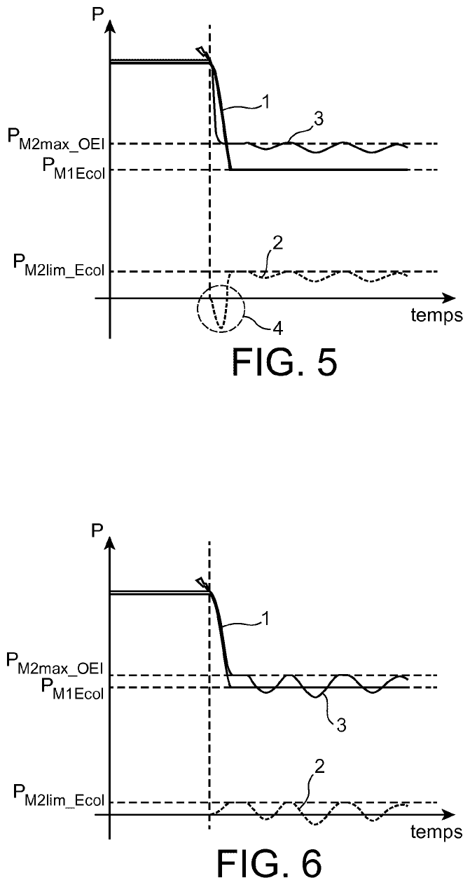

As illustrated in FIG. 5, this variant 1 consists in transiently controlling a negative power on the engine 20 (part of the curve designated by the circle 4), in order to obtain a drop in the total power that is more representative of the power profile resulting from a real case of engine failure.

It should be noted that there is no mention here of a transient power hole simulation, as it might be the case in the documents describing a method for simulating a fault OEI in a two-engine situation (cf., for example, the document [2]). This transient power hole simulation might be not necessary in the case of an electric hybrid propulsion system, since the engine 20 (electric) offers a much superior responsiveness than a gas turbine. Hence, this responsiveness intrinsic to the electrical technology can allow compensating very quickly for the power loss of the engine 10 and therefore eliminating, or at least greatly attenuating, the transient power hole following the fault. Nonetheless, the present invention can also simulate this transient power hole, without limitation. This can be done in three ways, which could potentially be combined:
the regulation system can transiently reduce the power of the engine 10 below PM1Ecol, before returning to this level;
the regulation system can also delay and/or slow down the power of the engine 20, so that the sum of the powers of the two motors is transiently lower than the maximum power that the second powertrain can deliver (denoted P_{M2max}) or to the power required by the aircraft P_{Rmin_Ecol};
according to the variant 1 proposed hereinabove, a negative power level can transiently be controlled on the engine 20, so that it draws power on the BTP. By acting on the duration of power drawing, it is possible to simulate a more or less long transient power hole before returning to the maximum power.

Moreover, the trade-off between the responsiveness of the engine 10 and the required minimum power P_{Rmin_Ecol} for the rest of the flight may be difficult to carry out. Two variants of the invention, described hereinbelow (hereinafter called variant 2 and variant 3), allow facilitating this trade-off by allowing selecting a level P_{M1Ecol} above the minimum power required for the continuation of the flight P_{Rmin_Ecol}.

The regulation system 5 maintains the engine 10 at the constant power PM1Ecol and continuously adapts the power of the engine 20 to the required level to maintain the rotational speed of the rotor at the desired speed.

P_{M2lim_Ecol}=P_{M2max_OEI}−P_{M1Ecol} The regulation system 5 also limits the power of the engine 20 to the level P_{M2lim Ecol} so that the total power delivered by the two engines does not exceed the maximum power P_{M2max_OEI} of the engine 20. Hence, the limit P_{M2lim_Ecol} is calculated as follows:

$${P}_{M 2 {lim}_{-} Ecol} = {P}_{M 2 max \_ OEI} - {P}_{M 1 Ecol}$$

P_{M2lim_Ecol}=P_{M2max_OEI}−P_{M1Ecol} Hence, the engine 20 thus operates at an average power level much lower than its maximum power, without this being perceptible by the pilot. This also has the advantage of consuming a much smaller amount of electrical energy, which could be interesting when the electrical energy is supplied by a battery the amount of available energy of which is necessarily limited.

Throughout the duration of the training, the engine parameters returned by the control system for the pilot display are “manipulated” so that they are representative of what would be displayed during a real fault situation. Thus, the speed, the torque or the power of the engine 10 is indicated at zero to represent its simulated fault status, while this same engine actually delivers a significant power level. Conversely, the equivalent parameters of the engine 20 are indicated at the levels where they would be if this engine was the only one to supply power to the rotor.

Still throughout the duration of the training, the regulation system continuously monitors the operation of the two engines. Thus, in the event of an actual fault detected on either engine, the regulation system immediately interrupts the failure training and simulation procedure and instantaneously reactivates the engine that is not affected by a fault, so that it delivers all the power necessary for continuing the flight.

### Variant 2: Use of the engine 2 in the brake mode in the rest of the training flight

In the variant 2, we act on the average power level delivered by the engine 1 in the rest of the training mode.

As mentioned hereinabove, the trade-off between the power required to maintain a good responsiveness of the engine 1 and the minimum power level necessary for the continuation of the training flight may be very difficult to meet.

To facilitate this trade-off, a variant of the invention consists in using the engine 2 in a reversible manner so as to be able to increase the power PM1Ecol of the engine 1. This solution can be carried out only if the engine 2 can draw mechanical power on the BTP and that the powertrain of the engine 2 is reversible, either by recharging a storage member (for example, a battery), or by instantaneously dissipating this power (for example through electrical power resistors).

According to this variant 2, the regulation system controls a power level P_{M1Ecol} higher than what would be controlled according to the basic invention. The power P_{M1Ecol} delivered by the engine 10 while a fault thereof is simulated, in this variant 2, higher than the minimum power of the flight P_{Rmin Ecol}. In order to maintain the rotational speed of the rotor at the desired level when P_{Rmin_Ecol}(t)<P_{M1Ecol}, the regulation system controls a negative power on the engine 20. Thus, the sum of the powers of the two engines is maintained at the level of the rotor need.

In this variant 2, the selection of the constant P_{M1Ecol} power is always subject to two constraints:
it should always be as high as possible to improve the responsiveness of the engine 10 in the event of a fault affecting the engine 20 during the training;

P_{M1Ecol}≤P_{Rmin_Ecol}−P_{M2min}—it cannot exceed the minimum power of the engine 20, P_{M2min}:

P_{M1Ecol}≤P_{Rmin_Ecol}−P_{M2min}

P_{M1Ecol}≤P_{Rmin_Ecol}−P_{M2min}This minimum power PM2min is here negative and corresponds (in absolute value) to the maximum power that the engine 20 can draw from the BTP. This minimum power P_{M2min} is not necessarily equal to the maximum power P_{M2max_OEI}, and may depend on the capacity of the powertrain of the engine 20 to absorb the power regenerated by this engine. In the case of an electrical powertrain, it may be the maximum recharging power of the battery, or the maximum power dissipated by the “braking resistors”. In the case where only one battery allows absorbing the power drawn by the engine 20, the minimum power P_{M2min} may also be constrained by energy considerations. Indeed, at any instant of the training flight, the energy regenerated by the engine 20 should not exceed the maximum capacity of the battery.

### Variant 3: Real-time adaptation of P_{M1Ecol} to eliminate the safety/representativeness trade-off for the selection of the constant P_{M1Ecol}

In the variant 3, we act on the average power level delivered by the engine 1 in the rest of the training mode.

It has been explained hereinabove that, during a training, PM1Ecol should be as high as possible in order to:
guarantee the safety of the flight in the event of an actual fault affecting the engine 20 while bearing in mind that:

the power loss due to the actual fault affecting the engine 20 will be all the lower as the engine 20 operates at low power (and therefore as the engine 10 operates at high power); the responsiveness of the engine 1 will be as more rapid as the engine 10 operates at high power (case of gas turbines only);
enable the engine 20 to operate at low power and thus preserve its energy source (particularly interesting if it is a battery, to enable sessions of training at coping with a fault affecting the engine 10 repeated without battery recharging).

On the other hand, it has also been explained that P_{M1Ecol} should be low enough for the engine 20 to be able to compensate for the power drops required by the rotor while complying with P_{M2inst}>P_{M2min} (with P_{M2min}=0 if the powertrain of the engine 20 is not reversible and P_{M2min}<0 if the powertrain of the engine 20 is reversible) in order to ensure good representativeness of the dynamic behaviour of the powertrain.

In practice, the trade-off aiming to define the constant P_{M1Ecol} hereinabove might be difficult to find (and even impossible).

In the variant 3, it is suggested to adapt in real-time the regime PM1Ecol over time, in order to make the engine 20 operate around a power that is just necessary (piloting margin) PM2_ref(t), in order to ensure a good representativeness of the dynamic behaviour of the powertrain. An example of real-time adaptation of P_{M1Ecol} is given in the following figures

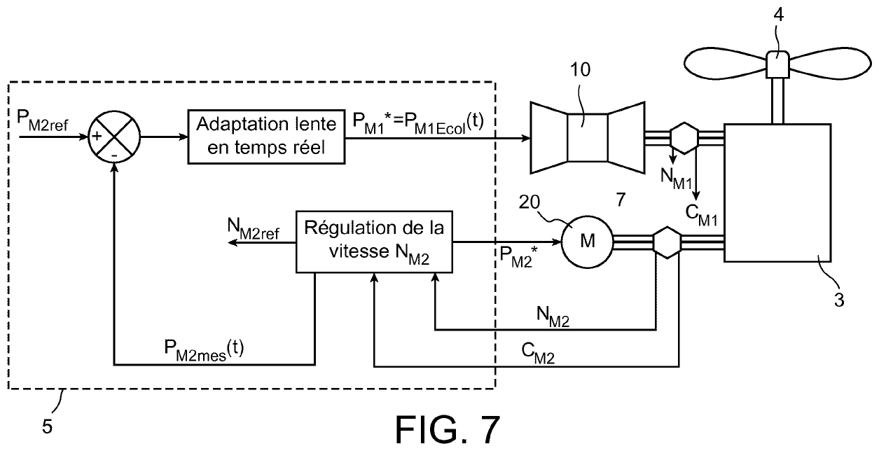

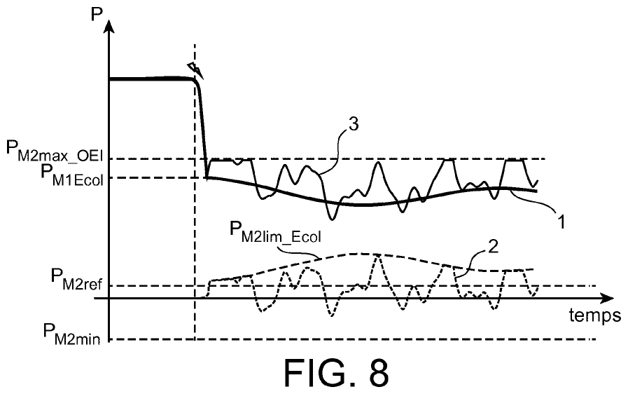

(FIGS. 7 and 8).

In FIG. 7, a particular embodiment of the variant 3 has been detailed in the regulation system.

The “slow” nature of the real-time adaptation of the power PM1Ecol enables the engine 20 (faster) to perfectly compensate for the additional power supplied to the rotor and thus to make the variations in the power of the engine 10 transparent to the pilot.

It goes without saying that in the case of the variant 3, it is also necessary to adapt in real-time the power limit of the engine P_{M2lim_Ecol} so that the total power supplied by the two engines never exceeds the maximum power of the engine 20:

$${P}_{M 2 {lim}_{-} Ecol} ( t ) = {P}_{M 2 max \_ OEI} - {P}_{M 1 Ecol} ( t )$$

In order to adapt the regime PM1Ecol of the gas turbine (turboshaft engine) in real-time, this adaptation may be carried out based, for example, on one or more of the elements listed hereinbelow:
control of the collective pitch of the aircraft;
the power anticipation information originating from the aircraft;
the power delivered by the engine 20, averaged over a given time period;
any other information allowing estimating the average level of power requirement of the rotor.

For example, it is possible to have:

$${P}_{M 1 Ecol} ( t ) = Low - Pass Filter ( {P}_{Helico} ( t ) - PM 2 ref )$$

where PM2ref is a constant value and where the real-time power of the helicopter (P_{Helico}(t)) is, for example, equal to:
P_{M1inst}(t)+P_{M2inst}(t), where P_{Minst}(t) is the power delivered in real-time by the first powertrain and P_{M2inst}(t) is the power delivered in real-time by the second powertrain; or
an estimated power of collective pitch type; or
a power estimated by the avionics; etc.

Hence, we will have on average:

$${P}_{M 1 Ecol} ( t ) = {P}_{M 1 inst} ( t )$$

P_{M2inst}(t)=P_{M2ref}, P_{M2ref} being the desired piloting margin.

It is specified that the dynamics of the low-pass filter should be slower than the possible dynamics of the first powertrain.

The above-described illustrative examples are based on a two-engine hybrid propulsion system. Nonetheless, the invention may cover any multi-engine application where training of the pilot consists in simulating the fault affecting an engine amongst several ones. Mention may be made, for example, of an architecture with three engines in parallel, one or two of these three engines being electric.

In addition, the above-described illustrative examples depict a situation of training a pilot to cope with a fault affecting a motor that no longer delivers power (total fault affecting an engine), since it is in general the most demanding situation in terms of piloting and the most restrictive in terms of simulation. Nonetheless, the invention may cover all situations of partial fault affecting an engine where the latter continues to deliver a given power level with more or less degraded performances. For example, mention may be made of the case of a total fault affecting the power regulation, so-called “freeze”, where the simulated faulty engine is frozen at a constant power level on a point of the flight domain.

### CITED REFERENCES

[1] U.S. Pat. No. 6,917,908 B2
[2] U.S. Pat. No. 8,025,503 B2
[3] EP 2 724 939 B1
[4] EP 2 886 456 A1

What is claimed is:

1. A method for training a pilot to cope with a fault affecting a powertrain of a hybrid propulsion system for an aircraft comprising n powertrains connected in parallel on a transmission unit, n being an integer greater than or equal to 2, including first and second powertrains that are heterogeneous in nature, the method comprising, during a flight of the aircraft, simulating a fault affecting the first powertrain by implementing the following steps:
decreasing the instantaneous power P_{M1nst} delivered by the first powertrain down to a training power P_{M1Ecol} and maintaining this power P_{MIEcol} until the end of the simulation, with:
P_{M2max_OEI}>P_{M1Ecol}>P_{M1min}
P_{M2max_OEI} being the instantaneous maximum power that could be delivered by the second powertrain when not in the training mode and P_{M1min} being the instantaneous minimum power that could be delivered by the first powertrain; and
increasing the instantaneous power P_{M2inst} delivered by the second powertrain up to a power that is lower than or equal to an upper limit power P_{M12lim_Ecol} applicable to the second powertrain in the training mode, and regulating the power PM2inst during the simulation so that the instantaneous total power P_{tot_Ecol} delivered by the first and second powertrains in the training mode is lower than or equal to P_{M2max_OEI}, with:
$${P}_{tot \_ Ecol} = {P}_{M 1 Ecol} + {P}_{M 2 inst} \\ {P}_{tot \_ Ecol} \leq {P}_{M 2 max \_ OEI} \\ {P}_{M 2 inst} \leq {P}_{M 2 {lim}_{-} Ecol} < {P}_{M 2 max \_ OEI} \\ {P}_{M 2 {lim}_{-} Ecol} + {P}_{M 1 Ecol} = {P}_{M 2 max \_ OEI}$$
P_{M2lim_Ecol} being the maximum power that could be delivered by the second powertrain in the training mode so that P_{tot_Ecol} does not exceed P_{M2max_OEI};
the method further comprising, at the same time as performing the simulation, checking the status of the n powertrains of the propulsion system and, if a fault affecting one of the n powertrains is detected, stopping the simulation and increasing the instantaneous power delivered by at least one amongst the first powertrain and the second powertrain, so that the sum of the instantaneous powers delivered by the n powertrains is higher than or equal to P_{Rmin_OEI}, P_{Rmin_OEI} being a minimum total instantaneous power required for the aircraft to continue its flight.

2. The method according to claim 1, wherein the second powertrain is selected from among a hydraulic or electrical type powertrain, and the first powertrain is selected from among a gas turbine type powertrain.

3. The method according to claim 1, wherein, the second powertrain being reversible, the step of increasing the instantaneous power P_{Minst} delivered by the second powertrain is preceded by a step of drawing, by the second powertrain, a portion of the instantaneous power P_{M1} delivered by the first powertrain to the transmission unit, whereby a faster drop in the instantaneous total power P_{tot_Ecol} delivered by the first and second powertrains during the simulation is obtained.

4. The method according to claim 1, wherein the step of decreasing the instantaneous power P_{M1inst} delivered by the first powertrain includes a transient reduction in the power of the first powertrain below P_{M1Ecol}, followed by an increase in the power of the first powertrain to P_{M1Ecol}.

5. The method according to claim 1, wherein the triggering of the step of increasing the instantaneous power P_{M2inst} delivered by the second powertrain is delayed and/or the increase of the instantaneous power P_{M2inst} delivered by the second powertrain is slowed, whereby a transient power hole is created.

6. The method according to claim 1, wherein, the second powertrain being reversible and P_{M1Ecol} being selected so as to be higher than or equal to P_{Rmin_Ecol} (P_{Rmin_Ecol} being the minimum total instantaneous power required for the aircraft to continue its flight in the training mode), a step of drawing a portion of the power delivered by the first powertrain to the transmission unit is carried out, by the second powertrain, at least once during the step of increasing the power delivered by the second powertrain, the maximum portion P_{M2min_Ecol} that could be drawn being a negative value and being equal, in absolute value, to the maximum power that the second powertrain could draw from the transmission unit in the training mode, with P_{M1Ecol}+P_{M2min_Ecol}≤P_{Rmin_Ecol}.

7. The method according to claim 6, wherein the power P_{M1Ecol} of the first powertrain and the power limit of the second powertrain P_{M2lim_Ecol} are adapted in real-time during the simulation, so that an average of the power of the second powertrain during the simulation is equal to a reference power PM2ref selected so as to guarantee a margin for piloting the aircraft, with P_{M2min}<P_{M2ref}<P_{M2lim_Ecol} and P_{M2lim_Ecol}(t)+P_{M1Ecol}(t)=P_{M2max_OEI}.

8. A device for training a pilot to cope with a fault affecting a powertrain of a hybrid propulsion system for an aircraft comprising n powertrains, n being an integer greater than or equal to 2, including first and second powertrains that are heterogeneous in nature and connected in parallel on a transmission unit, the device comprising control means configured to implement a training method according to claim 1.

9. An aircraft equipped with a hybrid propulsion system comprising n powertrains, n being an integer greater than or equal to 2, including first and second powertrains that are heterogeneous in nature and connected in parallel on a transmission unit, and a training device according to claim 8.
